(19) United States
(12) Patent Application Publication
(10) Pub. No.: US 2009/0246440 A1
(43) Pub. Date: Oct. 1, 2009

(54) SHIM

(76) Inventor: Timothy Olof Eagle, Middlesex (GB)

Correspondence Address: Intellectual Property Dept.;Dewitt Ross & Stevens SC, 2 East Mifflin Street, Suite 600, Madison, WI, 53703-2865, US

(21) Appl. No.: 10/597,279

(22) PCT Filed: Jan. 20, 2004
(86) PCT No.: PCT/GB2004/000204

§ 371 Date: Jun. 4, 2009

(51) Int. Cl. B32B 3/00; B32B 3/30

(52) U.S. Cl. 428/43; 428/156

(57) ABSTRACT

A shim (10) for use in the building industry is formed of first and second wedge elements (12, 14) which are substantially parallel to one another and are of an elongate configuration. Each wedge element (12, 14) is provided with retaining means along one longitudinal side thereof, which take the form of a line of teeth (16, 18). These teeth (16, 18) have the purpose of holding between adjacent teeth a nail or screw which would keep the shim (10) in position. The two wedge elements (12, 14) are coupled together by a coupling element (40) at the thick end of the shim (10). The coupling between the element (40) and the wedge elements (12, 14) is such that the elements (12, 14) act in a unitary manner, substantially as would a shim formed by a single wedge element. The break lines (34, 36) at the top of the wedge elements (12, 14) enable the user to detach the wedge elements (12, 14) from the coupling element (40) so that they can be used separately. This can be useful when a shim of smaller dimensions is required.

The present invention relates to a shim of the type used in the building trade.

Shims or wedges has been used for a long time to support various building elements, such as windows, doors, wall partitions and so on during construction. Traditionally, shims have been timber wedges, either produced specifically for the purpose or formed on site on an ad hoc basis. Producing such shims as and when needed is a time consuming and inefficient task. The manufacturing of such wooden shims also suffers difficulties inherent in wood as a material, including problems with sample variations, knots and so on. Moreover, shims made out of wood can split or break in unpredictable manners, making them difficult to use in practice.

It has been known to make shims out of other materials. For example, U.S. Pat. No. 6,155,004 discloses a shim made out of plastics material.

It is sometimes difficult to position shims easily on site, in particular in cases where the shim is not initially wedged in position. Moreover, different shims are required for different applications, which necessitates a workman to carry a variety of different shims to cover all foreseeable eventualities.

The present invention seeks to provide an improved shim.

According to an aspect of the present invention, there is provided a shim which includes a tapered body member provided with a plurality of wedge elements and at least one retaining member between said wedge elements, which retaining member is able to be engaged in a friction fit manner by a screw, nail or the like to retain the shim in a working position.

It is often desirable, for example when fitting a window, to be able to nail or screw the window loosely in position, then to correct the orientation of the window, and only then to tighten the fittings. With a shim according to the invention, the shim can be positioned during the first stage of the fitting process, with the shim being retained in position by the nail or screw but loose relative to the window frame. It is not necessary to hold the shim or otherwise fix it in position before adjusting the window alignment. This can provide a very significant advantage in practice.

Advantageously, the retaining member is deformable so as to deform around a screw, nail or the like. Preferably, the retaining member includes a plurality of retaining elements, the spacing between said elements and the rigidities thereof being sufficient to hold the shim in position when the retaining means engage a screw, nail or the like.

In the preferred embodiment, the retaining member includes a plurality of laterally extending and spaced fingers. The fingers are preferably resiliently deformable.

Advantageously, facing fingers are provided on facing sides of adjacent wedge elements, facing fingers being less than substantially 1 millimetre apart from one another. In the case where the shim is to be produced by moulding, due to the U-shape of the shim, there is a tendency for the two wedge elements to move towards one another during the product cooling stage. This arrangement of the fingers acts as a stop means, whereby as the elements move towards one another the facing fingers at the ends of the elements will eventually touch one another and stop further inwards movement of the wedge elements. Furthermore, the closeness of facing fingers assists in the retaining function.

Preferably, wherein retaining means are provided on each wedge element.

In an embodiment, the first and second side wedge elements extend in substantially the same direction and are connected to one another by at least one connecting member. The connecting member is preferably located at the thick end of each wedge element. This embodiment is preferably such that the two wedge elements can be separated and used independently of one another. Advantageously, at least one of said wedge elements has a width substantially equal to or less than the width of double glazed glass. Thus, the single design of wedge element can be used in two different applications, for the window frame and for aligning the pane of glass within the window frame. The worker need not carry two different types of shim.

For this purpose, said at least one wedge element preferably has a width of no more than 20 millimetres. Standard double glazing has a thickness of 16 to 20 millimetres.

Advantageously, the shim is provided with transverse break lines, preferably formed by V-shaped grooves. The shape of the grooves facilitates breaking of the shim by a worker.

In the preferred embodiment at least the wedge surfaces are smooth. This facilitates sliding of the shim into position and represents a departure from the prior art where shims were provided with rough surfaces to assist in retaining the shims in position.

Advantageously, there are provided recessed areas on at least one surface of the shim. These can hold glue, plaster, cement and the like to aid in securing the shim in position with the window frame, effectively as an integral component of the window assembly.

Preferably, the recessed areas constitute at least 50% of the surface area of a side of the shim in which the recessed areas are provided.

The shim may be made of a plastics material, metal or a fibrous material. According to another aspect of the present invention, there is provided a shim for building applications including first and second wedge elements arranged substantially coplanar to one another and a connecting element at a thick end of the shim, which connecting element enables the wedge elements to be used as a unitary shim, the wedge elements being detachable from the connecting element so as to be usable individually.

The term shim as used herein is intended to refer to shims, wedges and the like used in the building industry. Moreover, although the preferred embodiments may be described in relation to windows it is to be understood that the shim can have wider applications including but not limited to doors, flooring, roof lights and any other components requiring alignment and support during fitting.

Embodiments of the present invention are described below, with reference to the accompanying drawings, which:

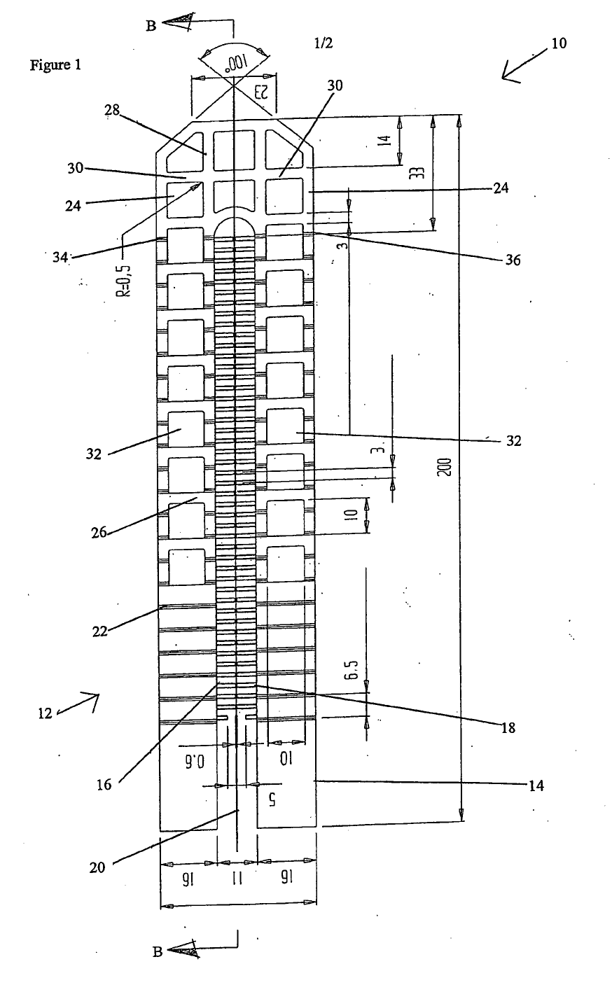

FIG. 1 shows in plan view an embodiment of shim;

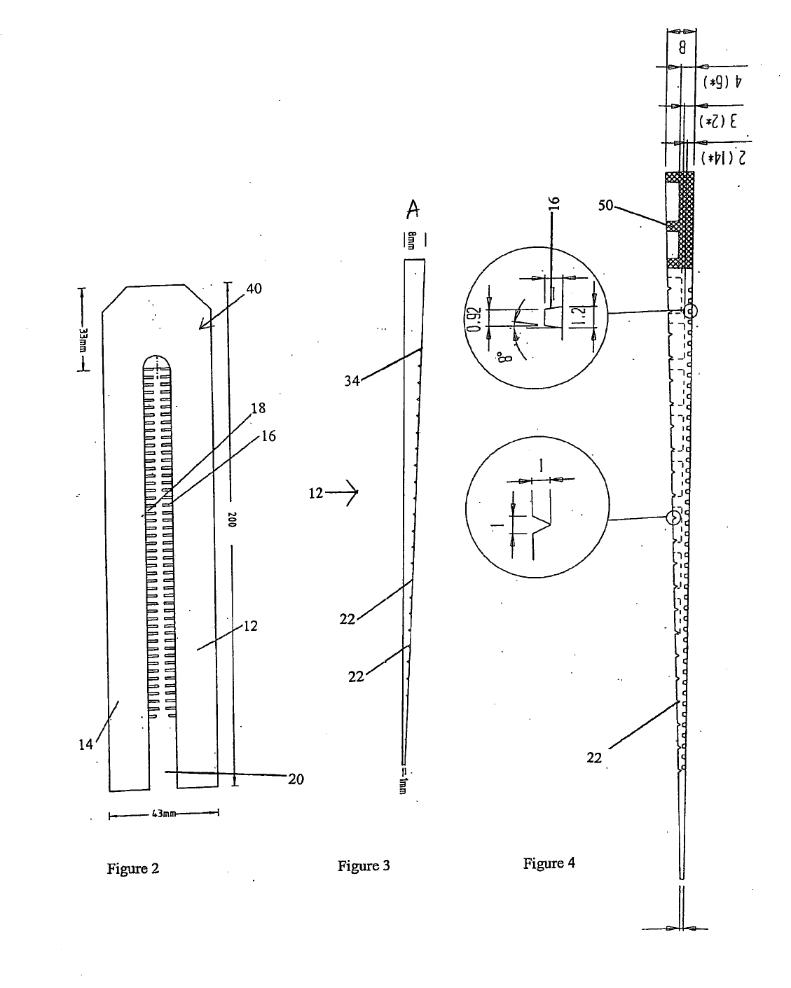

FIG. 2 shows an underside view of the shim of FIG. 1;

FIG. 3 shows a side elevational view of the shim of FIG. 1; and

FIG. 4 shows a cross-sectional view of the shim taken along line B-B of FIG. 1.

Referring to FIG. 1, there is shown an embodiment of shim or wedge for use in the building industry which is formed of first and second wedge elements 12, 14 which are substantially parallel to one another and are of an elongate configuration. FIG. 1 shows the dimensions of an embodiment of shim intended for use in the fitting of window frames and window panes. Of course, these dimensions shown are for one particular application and other dimensions and proportions would be used for other applications.

It can be seen that the shim 10 has a wedge-shape and in this embodiment has a thin front end of a thickness around 1 mm and a thick rear end of a thickness of around 8 mm. The shim 10 has an overall length of around 200 mm and an overall width of around 43 mm, with each wedge element 12, 14 having a width of 16 mm. Of course, these dimensions were chosen for this particular embodiment and other embodiments may very well have different dimensions.

Each wedge element 12, 14 is provided with retaining means along one longitudinal side thereof, which in this embodiment take the form of a line of teeth 16, 18, although in other embodiments any structure, such as a resilient flange, could be used. It will be seen that in the embodiments shown the rows of teeth, 16, 18 face one another within an interior gap 20 between the two wedge elements 12, 14. These teeth 16, 18 have the purpose of holding between adjacent teeth a nail or screw which would keep the shim 10 in position. This is particularly useful when the shim is located on other than, for example, a level surface such as a floor, in which it could move by the force of gravity or by some other external force.

The fact that the teeth 16, 18 face one another in the embodiment shown in FIG. 1 assists in retaining a screw or nail, which can become located between the two rows of teeth to be held by opposing pairs of teeth. For this purpose, the spacings between adjacent and facing teeth 16, 18 is sufficiently tight to accommodate the sizes of screws and nails usually used in such applications.

Each wedge element 12, 14 is provided on one surface thereof with a plurality of transverse break lines, formed by recessed V-shaped channels 22. These allow the shim 10 to be broken at any one of the locations of the break lines, which is often needed once the shim has been put in position.

It can also be seen from FIGS. 1 and 4 that the thicker part of the shim 10 is formed from an array of upstanding ribs 24-30 which cross one another, in this example substantially orthogonal to one another. This has the advantage of reducing the overall weight of the shim while retaining its structural strength and, evidently, the wedge-shape of the shim 10.

The recesses 32 which are formed by the upstanding ribs 24-30 also provide capture volumes into which fixing materials, such as filler, cement and so on, can flow, thereby forming a strong connection between the shim 10 and the building structure. As can be seen in particular in FIGS. 1 and 2, the two wedge elements 12, 14 are coupled together by a coupling element 40 at the thick end of the shim 10. The coupling between the element 40 and the wedge elements 12, 14 is such that the elements 12, 14 act in a unitary manner, substantially as would a shim formed by a single wedge element. The break lines 34, 36 at the top of the wedge elements 12, 14 enable the user to detach the wedge elements 12, 14 from the coupling element 40 so that they can be used separately. This can be useful when a shim of smaller dimensions is required or when the shim is required to support a smaller load, such as a window or the like.

Thus, the shim 10 in effect provides two different types of shim in a single unit (that is a bigger shim or wedge formed by the wedge elements 12, 14 together, and a smaller shim or wedge when they are used separately from one another). In this particular embodiment, the shim 10 used as a whole is useful for fixing of window frames to a window aperture in a wall, while the wedge elements 12, 14 can be used individually in the fitting of a pane of double glazing within the window frame. For this purpose, the wedge elements have a width of no more than 20 millimetres, which is typically the width of standard double glazing. An advantage of the teeth 16, 18 used as the retaining means in this embodiment is that they can be cut off easily by a worker, for example with a knife.

In FIG. 1 facing teeth 16,18 are spaced from one another by around 0.6 millimetres. As explained above, this enables the teeth 16, 18 also to be used as stops to stop inward movement of the arms 12, 14 following moulding.

As can be seen in FIG. 2, the rear surface of the shim 10 is substantially flat to assist in sliding the shim in position. This smooth surface, together with a generally smooth upper surface of the shim, facilitates in the sliding of the shim at its working location.

FIG. 4 shows that the thickness of the base wall 50 of the shim 10 increases towards the wide end. This enhances the strength of the shim.

1. A wedge-shaped shim having a tapered body member provided with a plurality of wedge elements and at least one retaining member between said wedge elements, which retaining member is able to be engaged in a friction fit manner by a fastener to retain the shim in a working position.

2. A wedge-shaped shim according to claim 1, wherein the retaining member is deformable so as to deform around fastener.

3. A wedge-shaped shim according to claim 1, wherein the retaining member includes a plurality of retaining elements having a spacing therebetween, the spacing between said elements and the rigidities thereof being sufficient to hold the shim in position when the retaining means engage a fastener.

4. A wedge-shaped shim according to claim 1, wherein the retaining member includes a plurality of laterally extending and spaced fingers.

5. A wedge-shaped shim according to claim 4, wherein the fingers are resiliently deformable.

6. A wedge-shaped shim according to claim 4, wherein facing fingers are provided on facing sides of adjacent wedge elements, facing fingers being less than substantially 1 millimetre apart from one another.

7. A wedge-shaped shim according to claim 1, wherein retaining means are provided on each wedge element.

8. A wedge-shaped shim according to claim 1, wherein the wedge elements include first and second wedge elements, and wherein the first and second wedge elements extend in substantially the same direction and are connected to one another by at least one connecting member.

9. A wedge-shaped shim according to claim 8, wherein the connecting member is located at a thick end of each wedge element.

10. A wedge-shaped shim according to claim 8, wherein the first and second wedge elements can be separated and used independently of one another.

11. A wedge-shaped shim according to claim 1, wherein at least one of said wedge elements has a width substantially equal to or less than the width of double glazed glass.

12. A wedge-shaped shim according to claim 11, wherein said at least one wedge element has a width of no more than 20 millimetres.

13. A wedge-shaped shim according to claim 1, wherein the shim is provided with transverse break lines.

14. A wedge-shaped shim according to claim 13, wherein the break lines are formed by V-shaped grooves.

15. A wedge-shaped shim according to claim 1, wherein the wedge elements include at least one smooth surface.

16. A wedge-shaped shim according to claim 1, including recessed areas on at least one surface of the shim.

17. A wedge-shaped shim according to claim 16, wherein the recessed areas constitute at least 50% of the surface area of a side of the shim in which the recessed areas are provided.

18. A wedge-shaped shim according to claim 1, wherein the shim is made of a plastics material, metal or a fibrous material.

19. A shim for building applications including first and second wedge elements arranged substantially coplanar to one another and a connecting element at a thick end of the shim, which connecting element enables the wedge elements to be used as a unitary shim, the wedge elements being detachable from the connecting element so as to be usable individually.

20-21. (canceled)

22. A shim which includes a tapered body member provided with a plurality of wedge elements arranged substantially coplanar to one another and a connecting element at a thick end of the shim, which connecting element enables the wedge elements to be used as a unitary shim, break lines being provided at the thick end of the wedge elements enabling detachment of the wedge elements from the connecting element so as to be usable individually, and at least one retaining member between said wedge elements, which retaining member is able to be engaged in a friction fit manner by a fastener to retain the shim in a working position.
